(19) United States
(12) Patent Application Publication
(10) Pub. No.: US 2015/0351438 A1
(43) Pub. Date: Dec. 10, 2015

(54) Micronutrient Fortification Delivery

(71) Applicant: OTC NUTRITION LLC, Manhattan, KS (US)

(72) Inventor: David K. Yang, Manhattan, KS (US)

(73) Assignee: OTC NUTRITION LLC, Manhattan, KS (US)

(21) Appl. No.: 14/763,171

(22) PCT Filed: Jan. 29, 2014
(86) PCT No.: PCT/US14/13542

§ 371 Date: Jul. 24, 2015

Related U.S. Application Data
(60) Provisional application No. 61/757,863, filed on Jan. 29, 2013.

(51) Int. Cl. A23L 1/304; A23L 1/00; A23L 1/303

(52) U.S. Cl. CPC A23L 1/304; A23L 1/3045; A23L 1/303; A23L 1/0067; A23V 2002/00

(57) ABSTRACT

Solid edible nutritional compositions or products which are fortified with one or more iron (II) mineral sources, and include one or more of ascorbic acid, edible ascorbic acid salts, erythorbic acid, or edible erythorbic acid salts as high ferric ion reducing agents which are physically and/or chemically separated to minimize chemical interaction in the presence of ambient moisture.

### CROSS-REFERENCE TO RELATED APPLICATIONS

This application makes reference to and claims the benefit of the following co-pending U.S. Provisional Patent Application No. 61/757,863 filed Jan. 29, 2013. The entire disclosure and contents of the foregoing Provisional Application is hereby incorporated by reference.

### FIELD OF THE INVENTION

The present invention broadly relates to solid edible nutritional compositions or products which are fortified with one or more iron (II) mineral sources, and include one or more of ascorbic acid, edible ascorbic acid salts, erythorbic acid, or edible erythorbic acid salts as high ferric ion reducing agents which are physically and/or chemically separated to minimize chemical interaction in the presence of ambient moisture.

### BACKGROUND

Mineral and vitamin supplements are recognized to be important for those who have inadequate diets, including children. In order to alleviate the problem of improper diet, supplementation of such diets with certain minerals and vitamins, such as by the use of vitamin pills, fortified foods (e.g., fortified beverages), other nutritional supplements, etc., may be required.

Several minerals may be necessary for complete nutrition, and iron is one of the most vital of these minerals. Iron supplementation may be required for some individuals who suffer (or may suffer) from iron deficiency in the diet. Iron stored in the body is generally depleted over time, thus potentially creating an iron deficiency. Such iron deficiency in certain individuals may eventually cause anemia. In this regard, nutritional supplements containing more bioavailable iron may be taken orally to provide iron fortification, using, for example, ferrous salts such as ferrous sulfate sold commercially in iron supplements under the trade names Feratab, Fer-Iron, ferrous bis-glycinate (Ferrochel®), etc.

Calcium is the fifth most abundant element in the human body, and plays an important role in many physiological processes, including nerve and muscle functions. Calcium deficiency may interfere with muscular contraction and can also result in depletion of skeletal calcium. Osteoporosis is also a recognized nutritional problem, and numerous calcium fortified compositions are presently being marketed in an attempt to overcome this problem.

Of the vitamins, ascorbic acid (vitamin C) may be considered one of the more essential because of the important role played by this vitamin in collagen formation, teeth and bone formation and repair, in the prevention of scurvy, etc. Ascorbic acid may be found naturally in many fruits and vegetables, but because this vitamin is water soluble, ascorbic acid may not be stored in the body for any appreciable period of time. For these reasons, ascorbic acid may be included in various fortified beverages now being marketed so that it may be consumed on a daily basis. Beside vitamin fortification, ascorbic acid (including its asorbate salts) may be included in various formulations as an antioxidant.

Micronutrient fortification of food and beverages with certain of these minerals may be difficult because of the poor solubility of some of these mineral nutrients such as iron and calcium salts, and their reactivity with other nutrients causing undesirable organoleptic qualities and functional acceptance, for example discoloration. Highly soluble mineral nutrients, for example, ferrous bis-glycinate and calcium citrate malate (CCM) are known in the art to be of high solubility for food and beverage applications and have been found to be more bioavailable without compromising consumer taste acceptance than other mineral fortification sources. Additional fortification with essential micronutrients (vitamin A, vitamin C, vitamin E, folate, B₁₂, B₂, B₆ and niacin) at meaningful levels designed to meet the need of different age groups including preschool children, school children, adolescents and pregnant women may also be desirable, for example, a single serving which provides 15-35% vitamin A, 25-30% iodine, 25% zinc and 15-25% B-vitamins. In order to meet consumer acceptability, fortification with, for example, multiple micronutrients should avoid affecting overall taste, color, flavor, and stability.

### SUMMARY

According to a first broad aspect of the present invention, there is provided a product comprising a solid edible nutritional composition, which contains:
a nutritionally supplemental amount of one or more iron (II) mineral sources; and
a high ferric ion reducing agent comprising one or more of: ascorbic acid, edible ascorbic acid salts, erythorbic acids, or edible erythorbic acid salts in amount sufficient to measurably retard conversion of the iron (II) mineral sources from ferrous to ferric species when the solid edible nutritional composition is solubilized in an aqueous liquid;
wherein the iron (II) mineral sources and the high ferric ion reducing agent are physically and/or chemically separated to minimize chemical interaction in the presence of ambient moisture.

According to a second broad aspect of the present invention, there is provided a product comprising a solid particulate edible nutritional mixture, which contains:
nutritionally supplemental amount of iron (II) mineral source particulates, each of the iron (II) mineral source particulates comprising:
   a first solid edible core; and
   at least one edible layer comprising one or more iron (II) mineral sources on the first core; and
high ferric ion reducing agent particulates in amount sufficient to measurably retard conversion of the iron (II) mineral sources from ferrous to ferric species when the solid particulate edible nutritional mixture is solubilized in an aqueous liquid, each of the high ferric ion reducing agent particulates comprising:
   a second edible core; and
   at least one edible one layer on the second core and comprising one or more of: ascorbic acid, edible ascorbic acid salts, erythorbic acids, or edible erythorbic acid salts;
wherein the iron (II) mineral particulates and the high ferric ion reducing agent particulates minimally interact chemically in the presence of ambient moisture.

According to a third broad aspect of the present invention, there is provided a process for preparing a solid particulate edible nutritional mixture, which comprises the following steps:
(a) forming iron (II) mineral source particulates by applying at least one edible layer comprising one or more iron (II) mineral sources to a first edible core;
(b) forming high ferric ion reducing agent particulates by applying at least one edible layer comprising one or more of: ascorbic acid, edible ascorbic acid salts, erythorbic acids, or edible erythorbic acid salts, to a second edible core; and
(c) combining a nutritionally supplemental amount of the iron (II) mineral source particulates with the high ferric ion reducing agent particulates in an amount sufficient to measurably retard conversion of the iron (II) mineral sources from ferrous to ferric species when the solid particulate edible nutritional mixture is solubilized in an aqueous liquid, wherein the iron (II) mineral source particulates and the coated high ferric ion reducing agent particulates minimally interact chemically in the presence of ambient moisture.

### DETAILED DESCRIPTION

It is advantageous to define several terms before describing the invention. It should be appreciated that the following definitions are used throughout this application.

### DEFINITIONS

Where the definition of terms departs from the commonly used meaning of the term, applicant intends to utilize the definitions provided below, unless specifically indicated.

For the purposes of the present invention, the terms “edible,” refers to any product, composition, component, ingredient, additive, material, etc., which may be orally ingested, and which is generally safe for humans, other animals, etc., to eat. Edible products and edible compositions may include, for example, foods (e.g., beverages, pet foods, etc.), nutritional supplements, products for preparing such foods and supplements, etc.

For the purposes of the present invention, the terms “food”, “food ingredient” or “food product” refer to the common meaning of these terms and include any product classified as a “food” by the U.S. Food and Drug Administration, including weight loss products, meal replacement products, etc. Food products may include any product that may be directly drunk or ingested or that may be further mixed with other ingredients to form a product that may be drunk or ingested. For example, a food product may be mixed with an aqueous liquid to form a drink, etc. A food product may in various forms such as, for example, a nutritional supplement, a nutritional beverage, a tablet or powder (e.g., a beverage tablet or powder, etc.) used to form an ingestible food such as a liquid drink or beverage, vitamin fortified waters, fruit juices such as: apple juice, orange juice, grape juice, grapefruit juice, cranberry juice, etc., vegetable juices such as tomato juice, carrot juice, etc., mixtures of fruit and/or vegetable juices, coffee, tea, milk, etc.

For the purposes of the present invention, the term “food additive” refers to the common meaning of the term “food additive” and includes any product classified as a “food additive” by the U.S. Food and Drug Administration. Food additives may include, for example, non-caloric sweeteners, colorants, flavorants, bulking agents (e.g., polydextrose), fat substitutes such as olestra, etc.

For the purposes of the present invention, the term “nutritional supplement” refers to a product, composition, etc., which may provide nutritional benefits in terms of, for example, providing nutritional minerals, vitamins, etc. Nutritional supplements may include tablets, powders, energy beverages (e.g., energy drinks, etc.), etc.

For the purposes of the present invention, the term “nutritionally supplemental amount” refers to an amount of a nutritional mineral source, vitamin, etc., which provides a measurable nutritional benefit to the individual consuming the edible nutritional product, composition, etc. Nutritionally supplemental amounts of a particular nutritional mineral source, vitamin, etc., may be measured in terms of RDA values.

For the purposes of the present invention, the term “RDA” refers to the Recommended Dietary Allowances for minerals, vitamins, etc., including iron (II) mineral sources, calcium mineral sources, other trace minerals, vitamin C, vitamin D, etc. These Recommended Dietary Allowances (RDAs) are a set of estimated nutrient allowances established by the National Academy of Sciences, which may be updated periodically to reflect current scientific knowledge.

For the purposes of the present invention the term “serving” refers to the appropriate serving size for a food product, for example, a nutritional beverage, weight loss product, meal substitute, etc., a nutritional supplement, etc., as established by the United States Food and Drug Administration (FDA) and the Nutrition and Labeling Act (NLEA), as set forth in 21 C.F.R §101, or any subsequent version of the FDA regulatory rules that may correspond to 21 C.F.R §101. Embodiments of the present invention also adopt the NLEA's definition of a serving size as being the amount of food customarily eaten at one time. When embodiments of the food product of the present invention comprise a nutritional beverage or liquid meal substitute, a typical serving size may be from about 230 to about 530 mL. A single serving of the food product may be packaged in various types of, for example, “single serving” packages/containers (e.g., delivery straws such as drink straws) that are known in the art.

For the purposes of the present invention, the terms “solids basis” and “dry basis” refer interchangeably to the weight percentage of each of the respective solid compounds, components, ingredients, materials, substances, etc. (e.g., iron (II) mineral sources, edible high ferric ion reducing agents such as ascorbic acid, other mineral sources such as calcium and other trace minerals, edible carboxylic acids, such as a citric and malic acid component, vitamins, edible carbon dioxide-generating bicarbonate component, etc.) present in the absence of any liquids (e.g., water). Unless otherwise specified, all percentages given herein for solid compounds, components, ingredients, materials, substances, etc., are on a solids basis.

For the purposes of the present invention, the term “solid” refers to compositions, compounds, components, ingredients, materials, etc., which are characterized by structural rigidity and resistance to changes of shape or volume at the temperature of use (e.g., room temperature).

For the purposes of the present invention, the term “solid nutritional composition” refers to embodiments of the edible nutritional compositions that are solid at room temperature. Solid nutritional compositions may be in the form of, for example, tablets such as capsules, pills, wafers, lozenges, etc.; particulates such as beads, pellets, granules, powders, etc.; etc. Embodiments of the solid nutritional compositions of the present invention may have a moisture content of, for example as high as about 15% by weight of the product and as low as less than about 2% by weight of the product. Products comprising embodiments of the solid nutritional compositions of the present invention may be in an amount of from about 2.5 to about 5 g. (e.g., about 3 g), and sufficient to provide an ingestible or drinkable beverage when combined with about 8 oz. of an aqueous liquid (e.g., water, fruit juice, etc.).

For the purposes of the present invention, the term “liquid” refers to a non-gaseous fluid composition, compound, component, ingredient, material, etc., which may be readily flowable at the temperature of use (e.g., room temperature) with little or no tendency to disperse and with a relatively high compressibility.

For the purposes of the present invention, the term “liquid” nutritional composition refers to nutritional compositions that are liquid at room temperature and prepared by combining an edible solid nutritional composition with an aqueous liquid (e.g., water). Liquid nutritional compositions may be in the form of solutions, etc., for example, aqueous foods (i.e., those comprising water as solubilizing agent, with or without other solubilizing agents, carriers, etc., such, as for example, alcohol, etc.). Examples of liquid foods may include: beverages or drinks (e.g., soda), fruit juices, vegetable juices, coffee, tea, milk, etc. Examples of liquid nutritional supplements may include: liquid concentrates, extracts, energy beverages (e.g., energy drinks, etc.), etc.

For the purposes of the present invention, the term “calcium mineral source” refers to any source of calcium which may form a calcium citrate malate chelate complex with a citric and malic acid component in an aqueous liquid. Besides forming a calcium citrate malate chelate complex, such calcium mineral sources additionally provide a nutritional benefit. These calcium mineral sources may include one or more of: calcium hydroxide (also referred to as “calcium hydrate” or “hydrated lime”), calcium carbonate, calcium citrate, calcium malate, calcium oxide, calcium chloride, calcium phosphates/calcium hydrogen phosphates (e.g., monobasic calcium phosphate, dibasic calcium phosphate, tricalcium phosphate, etc.), calcium sulfate, calcium lactate, calcium benzoate, calcium ascorbate, calcium sorbate, calcium lactate gluconate, calcium propionate, calcium acetate, calcium caseinate, calcium cyclamate, calcium panthothenate, calcium stearate, calcium stearyl lactylate, etc.

For the purposes of the present invention, the term “calcium citrate malate chelate complex” refers to an at least meta-stable chelate complex of calcium with citrate and malate anions and which provides solubilized calcium in an aqueous liquid (e.g., in water). Besides increasing calcium solubilization, another benefit of calcium citrate malate is that this complex does not interfere, or at least does not interfere in a significant way with the bioavailability or absorption of other minerals (including trace minerals), for example, iron. The weight ratio of citrate to malate in such calcium citrate malate chelate complexes may, for example, be in the range of from about 4:1 to about 1:3, such as from about 2:1 to about 1:3, e.g., from about 2:1 to about 1:1.

For the purposes of the present invention, the term “citric and malic acid component” refers to an acid component which comprises a mixture of citric acid and malic acid (e.g., in an amount of from about 95 to 100% by weight, such as from about 98 to 100% by weight). In addition to citric acid and malic acid, the citric and malic acid component may optionally comprise one or more edible carboxylic acids such as fumaric acid, maleic acid, succinic acid, malonic acid, glutaric acid, adipic acid, aspartic acid, glutaconic acid, glutamic acid, phosphoric acid, etc., as well as any edible salts such of edible carboxylic acids (e.g., sodium salt, potassium salt, calcium salt, magnesium salt, etc.).

For the purposes of the present invention, the term “total tritratable acids” refers to the combined amount of free (i.e., non-complexed, non-chelated) citric acid and free malic acid (plus any other optional edible carboxylic acids) which are present in the solid edible nutritional composition. The amount of free citric and free malic acid (plus any other optional edible carboxylic acids) may be sufficient to provide a level of total tritratable acids of, for example, at least about 0.02% by weight (such as at least about 0.2% by weight) when solubilized in the aqueous liquid, for example, from about 0.02 to about 0.7% by weight, such as from about 0.2 to about 0.7% by weight (e.g., from about 0.3 to about 0.5% by weight, or from about 0.03 to about 0.05% by weight).

For the purposes of the present invention, the term “iron (II) mineral source(s)” refers to any source of iron which may provide nutritional benefit, and which may exist in the divalent state (e.g., are “ferrous” compounds/salts). Suitable iron (II) mineral sources may include one or more of: ferrous bis-glycinate (e.g., Ferrochel®), ferrous glycine sulfate (ferroglycine sulfate), ferrous fumarate, ferrous gluconate, ferrous succinate, ferrous lactate, ferrous citrate, ferrous sulfate, ferrous ammonium sulfate, ferrous iodide, etc. See U.S. Provisional Pat. Appln. Ser. No. 61/588,680 (Yang), filed Jan. 20, 2012, and corresponding PCT Appln. No. WO 2013/109516 (Yang), published Jul. 15, 2013, the entire disclosure and contents of which are herein incorporated by reference.

For the purposes of the present invention, the term “high ferric ion reducing agent” refers to an agent which measurably retards the tendency of ferrous cationic species to be oxidized (converted) to ferric cationic species (i.e., tends to reduce the ferric species and thus creates a high reducing potential environment for the ferrous species). Edible high ferric ion reducing agents may include one or more of: ascorbic acid, edible ascorbic acid salts (e.g., sodium ascorbate, potassium asorbate, etc.), erythorbic acid (the stereoisomer of ascorbic acid), or edible erythorbic acid salts (e.g., sodium erythorbate, potassium erythorbate, etc.), as well as edible ascorbic acid esters (e.g., ascorbyl palmitate, ascorbyl stearate, etc.), edible erythorbic acid esters (e.g., erythorbyl palmitate, erythorbyl stearate, etc.), etc.; sulfites, such as sodium sulfite, potassium sulfite, etc.; etc. Besides functioning as a high ferric ion reducing agent, any ascorbic acid, erythorbic acid, and/or edible ascorbic/erythorbic acid salts present, as well as the respective edible ascorbic acid esters and/or edible erythorbic acid esters, may additionally provide nutritional benefit as a source of vitamin C, may impart other antioxidant benefits, etc. See U.S. Provisional Pat. Appln. Ser. No. 61/588,680 (Yang), filed Jan. 20, 2012, and corresponding published PCT Appln. No. WO 2013/109516 (Yang), published Jul. 25, 2013, the entire disclosure and contents of which are herein incorporated by reference.

For the purposes of the present invention, the term “bioavailable” refers to a mineral source (e.g., a calcium mineral source, an iron (II) mineral source, etc.) which is available for absorption by the gut.

For the purposes of the present invention, the term “vitamin C” refers to compounds, compositions, etc., which may include ascorbic acid (L-ascorbic acid), edible salts of ascorbic acid (L-ascorbate salts), etc., edible esters of ascorbic acid (ascorbyl palmitate), etc., as well as mixtures thereof.

For the purposes of the present invention, the term “vitamin D” refers to compounds, compositions, etc., which may include vitamin D₃, vitamin D₂, 25(OH)D₃, 25(OH)D₂, 1α,25(OH)₂ D₃, 1α,25(OH)₂ D₂, etc., as well as mixtures thereof.

For the purposes of the present invention, the term “trace minerals” refers to those minerals, other than iron and calcium, which may be important for bone growth and age-related bone health. These trace minerals may include, for example, one or more of: zinc, magnesium, manganese, copper, potassium, etc., as well as mixtures thereof.

For the purposes of the present invention, the term “carbon dioxide-generating bicarbonate component” refers to a composition, compound, material, ingredient, etc., which comprises bicarbonates and which are capable of generating carbon dioxide (gas) in an aqueous liquid in the presence of edible carboxylic acids, for example a citric and malic acid component comprising a citric acid and malic acid. Suitable edible solid carbon dioxide-generating bicarbonate components for use herein may include one or more of: edible monovalent cation bicarbonates such as sodium bicarbonate, potassium bicarbonate, ammonium bicarbonate, etc.

For the purposes of the present invention, the term “sweetener(s)” refer to sugars, as well as non-caloric sweeteners, and any combinations thereof.

For the purposes of the present invention, the term “an amount sufficient to aid in dispersing the calcium mineral source in the aqueous liquid” refers to an amount of the edible solid carbon dioxide-generating bicarbonate component which is effective to generate sufficient carbon dioxide (gas) in an aqueous liquid in the presence of edible carboxylic acids, for example a citric and malic acid component comprising a citric acid and malic acid, to create sufficient agitation, bubbling, mixing, stirring, etc., in the aqueous liquid and thus cause measurable dissolution, dispersion, etc., of, for example, the calcium mineral source in the aqueous liquid, but without significantly inhibiting the chelate complex formation between the calcium mineral source and the citric and malic acid component in the aqueous liquid. Suitable amounts of the edible solid carbon dioxide-generating bicarbonate component may be, for example, in a weight ratio of the edible solid carbon dioxide-generating bicarbonate component to, for example, a citric and malic acid component, of from about 1:1 to about 1:4.5, such as from about 1:1.1 to about 1:3.

For the purposes of the present invention, the term “particulate” refers to a solid particle, bead, granule, pellet, powder, etc., which may comprise the iron (II) mineral source(s) (with our without other components such as other mineral sources (e.g., calcium, magnesium, zinc, etc., vitamins, acidulants, binders, emulsifiers, flavorants, colorants, etc.), the high ferric ion reducing agent(s) (with or without other components such as such as other mineral sources (e.g., calcium, magnesium, zinc, etc., vitamins, acidulants, binders, emulsifiers, flavorants, colorants, etc.), etc. Particulates may (but do not necessarily) have a relatively spherical or oblong shape. These particulates may also be in the form of coated particulates or uncoated particulates.

For the purposes of the present invention, the term “tablet” refers to a solid pill, wafer, capsule, lozenge, etc., and which may comprise the iron (II) mineral source(s) (with our without other components such as other mineral sources (e.g., calcium, magnesium, zinc, etc., vitamins, acidulants, binders, emulsifiers, flavorants, colorants, etc.), the high ferric ion reducing agent(s) (with or without other components such as such as other mineral sources (e.g., calcium, magnesium, zinc, etc., vitamins, acidulants, binders, emulsifiers, flavorants, colorants, etc.), etc. Tablets may (but do not necessarily) have a relatively flattened, somewhat circular disc-like shape, e.g., such that the diameter thereof is greater than its thickness. Embodiments of the tablets of the present invention may have a diameter, for example, in the range of from about 50 to about 250 mm, such as from about 100 to about 200 mm. These tablets may also be in the form of coated tablets or uncoated tablets.

For the purposes of the present invention, the term “particle size diameter” refers to those particulates having a certain diameter. The ranges of particles size diameters referred to herein may be determined, measured, etc., by, for example, which particles pass through a first screen of a specified mesh size, but are then retained on a second screen of another specified mesh size which has a mesh size smaller than that of the first screen. Embodiments of the particulates of the present invention may have a particle size diameter in the range of from about 0.5 to about 250 mm, such as from about 0.5 to about 10 mm, e.g., from about 3 to about 4 mm, from about 2 to about 3 mm, etc.

For the purposes of the present invention, the term “core” refers to the interior, center, etc., of the particulates and which provides, serves as, etc., a carrier, support, etc., for other components present in the particulates. The core comprises a nucleus (e.g., a “seed”) material which may be a sugar, sugar alcohol, starch, starch derivative, other polysaccharide, etc., for carrying, supporting, etc., the one or more layers applied to or on the core, as well as other optional edible materials such as flavorants, emulsifiers, etc. In some embodiments of the core (e.g., those including substantially water insoluble ingredients, for example, substantially water-insoluble flavorants, such as chocolate), the core may also comprise an exterior coating, film, etc., which may comprise emulsifiers (e.g., for solubilizing the substantially water insoluble materials), edible oils, sweeteners, binders, etc.

For the purposes of the present invention, the term “nucleus material(s)” refers to solid compounds, compositions, materials, ingredients, etc., which may be present in the core of a particulate and which provides, serves as, etc., the material for initiating the support, foundation, base, etc., for applying, coating, adhering, etc., successive layers in preparing, forming, etc., the particulate. Suitable edible nucleus materials for use in embodiments of the present invention may include one or more of: sugars, sugar alcohols, polysaccharides (e.g., starches, starch derivatives, other polysaccharides, etc.) such as maltodextrin, other dextrins, microcrystalline cellulose, polydextrose, edible gums (e.g., gum arabic, guar gum agar, alginates, carrageenans, gum tragacanth, karaya gum, locust bean gum, etc.) etc.

For the purposes of the present invention, the term “binder(s)” refers to compounds, compositions, materials, ingredients, etc., which may be used to assist in adhering, forming, growing, etc., one or more layers on the edible core in preparing, forming, providing, etc., the particulates, as well as providing cohesion for compounds, compositions, materials, ingredients, etc., present in other solid forms of embodiments of the present invention, such as tablets, etc. Suitable binders may include, for example, one or more of: sugars, starches, starch derivates such as modified starch, maltodextrin, other dextrins, etc., other polysaccharides such as microcrystalline cellulose, polydextrose, edible gums (e.g., gum arabic, guar gum agar, alginates, carrageenans, gum tragacanth, karaya gum, locust bean gum, etc.), etc. In some embodiments, binders, for example, sugars, starches, starch derivates other polysaccharides, etc., may also function additionally or solely as nucleus materials for the core.

For the purposes of the present invention, the term “sugar(s)” refers to monosaccharides or disaccharides such as sucrose, glucose (dextrose), fructose, lactose, maltose, corn syrup solids, etc., as well as sugar syrups such as high fructose corn syrup, honey, agave syrup, etc.

For the purposes of the present invention, the term “sugar alcohol(s)” refers to a polyhydric polyol derived, for example, from a sugar, such as sorbitol, mannitol, malitol, xylitol, lactitol, erythritol, etc.

For the purposes of the present invention, the term “starch(es)” refers to polysaccharides such as tapioca, corn starch, soy starch, wheat starch, sorghum, rice starch, etc.

For the purposes of the present invention, the term “starch derivative(s)” refers to derivatives of starches such as modified starch, maltodextrin, other dextrins, etc.

For the purposes of the present invention, the term “layer(s)” refers to the exterior coating, film, etc., of the particulates comprising either the iron (II) mineral sources or the high ferric ion reducing agents (as well as any other optional components), and which is applied on or to the edible core. In embodiments of the present invention, a plurality (i.e., more than one) of layers may be applied to or on the core, and may completely or partially cover, encompass, surround, encapsulate, enclose, envelop, etc., the core.

For the purposes of the present invention, the term “physically and/or chemically separated” refers to the iron (II) mineral sources and the reactive high ferric ion reducing agent being physically separate from each other (e.g., being present in separately formed particulates, including separately formed particulates having protective coatings which may further inhibit chemical interaction in the presence of ambient moisture), being separated by physical and/or chemical barriers, e.g., may be present in the same particulates but in separately formed layers (with or without additional protective barrier materials being interposed between adjacent layers) which do not chemically interact in the presence of ambient moisture, etc.

For the purposes of the present invention, the term “ambient moisture” refers to the amount of moisture normally present in the atmosphere or native environment. Ambient moisture may be present, for example, in an amount of as much as about 100% (i.e., as relative humidity), but is usually present at less than about 50%, and may be as low as less than about 2%.

For the purposes of the present invention, the term “room temperature” refers to the commonly accepted meaning of room temperature, i.e., an ambient temperature of 20° to 25° C.

For the purposes of the present invention, the terms “container” and “package” are used interchangeably and refer to a package or container that contains the embodiments of the edible solid nutritional composition of the present invention. The specific type of package or container, either of a single-serving size or any other size, used as a container for the embodiments of the edible solid nutritional composition of the present invention may depend on such factors as whether the composition is a tablet, particulates, etc., whether the composition includes perishable components, whether the composition is sensitive to moisture, oxygen, etc. Suitable containers and/or packages may include, for example, a delivery straw (e.g., drink straw), sachet, packet, envelope, bottle, etc.

For the purposes of the present invention, the term “comprising” means various compounds, components, ingredients, substances, materials, layers, steps, etc., may be conjointly employed in embodiments of the present invention. Accordingly, the term “comprising” encompasses the more restrictive terms “consisting essentially of” and “consisting of.”

For the purposes of the present invention, the term “and/or” means that one or more of the various compositions, compounds, ingredients, components, elements, capabilities, steps, etc., may be employed in embodiments of the present invention.

### DESCRIPTION

More bioavailable nutrients in ready-to-drink beverage products and ready-to-mix powered beverage products may be formulated without compromising appearance and taste free of aftertaste and off-flavor through both chelation and redox modulation chemistry. (Mehansho H. J. Nutr. 136: 1059-1063, 2006). Even so, providing edible nutritional compositions or products, such as nutritionally fortified beverage compositions or products, which contain such catalytically active polyvalent mineral cations such as iron may create some significant challenges. For example, water-soluble iron compounds are the most nutritionally bioavailable iron sources. But inclusion of such iron mineral sources in edible nutritional compositions or products, such as nutritionally fortified beverage compositions or products, may cause adverse interactions (e.g., reactions) with other components (e.g., anthocyanins, other flavanoids, polyols, etc.), thus causing degradation of, depletion of, chemical changes in, etc., such other components, including the iron mineral source, as well as causing undesirable taste effects (e.g., unacceptable organoleptic changes such as metallic aftertaste), discoloration effects, oxidative deterioration of flavors, etc., in such compositions or products that may shorten product life due to such changes or effects.

Highly soluble mineral sources, for example, iron (II) mineral sources, such as ferrous bis-glycinate (an amino-acid chelated iron (II) source), may provide in edible nutritional supplements, such as fortified foods and beverages, a more bioavailable source of such minerals. But inclusion of such mineral sources without compromising consumer taste acceptance may present unique challenges. While iron (II) mineral sources, such as ferrous bis-glycinate, may be used to minimize, reduce, diminish, inhibit, retard, avoid, prevent, etc., iron-mediated metallic aftertastes, like those caused by other water-soluble iron compounds, ferrous bis-glycinate may be easily oxidized to the ferric iron (III) cationic species in an aqueous liquid. The creation of such ferric iron (III) cationic species may cause further off-flavor development, off-color development, etc., in such aqueous liquids. For example, ferrous bis-glycinate by itself, when added to water or other aqueous liquids, may impart a deep rusty yellow color which may cause unacceptable off-color development in, for example, liquid beverages by interacting with flavanoids, including color and flavor compounds such as anthocyanins. Anthocyanins may be commonly found in many fruits and vegetables and richly concentrated in berries, such as blueberries, cranberry, bilberry, black raspberry, red raspberry, blackberry, black currant, cherry, concord grape, black chokeberry, acai, beet, eggplant, tea leaves, etc. Accordingly, consumption of such fruits high in anthocyanins may provide potential health benefits in terms of cancer, aging, neurological diseases, inflammation, diabetes, bacterial infections, etc. But when present, anthocyanins may also be highly reactive when exposed to air, and may thus react and cause degradation of other fruit components, such as ascorbic acid, even at pHs as low as, for example, a pH of about 2.0 in which anthocyanins may be more stable. (Such oxidative reactions of anthocyanins may also be further catalyzed by the presence of iron and copper.)

In aqueous compositions and products having a pH of, for example, less than about 5, a high ferric ion reducing agent such as ascorbic acid, erythorbic acid, the respective salts of ascorbic or erythorbic acid, etc., may be used to minimize, reduce, diminish, inhibit, avoid, prevent, retard etc., oxidation of ferrous cationic species to the respective ferric cation species. See Mehansho, Nutr. 136: 1059-1063 (2006). But in the presence of the surrounding ambient moisture/humidity (e.g., even at less than about 2% ambient moisture), including moisture/humidity present in the surrounding ambient air, the combination of an iron (II) mineral source (such as ferrous bis-glycinate) and ascorbic acid, erythorbic acid (or their respective salts) as the high ferric ion reducing agent in a solid mixture may cause a chemical interaction between the iron (II) mineral source and the high ferric ion reducing agent. This chemical interaction may manifest itself as a rapid discoloration in the solid mixture, for example, resulting in this mixture darkening and turning black in color. In particular, in a low water activity or dry-state, a concentrated micronutrient premix comprising ferrous bis-glycinate and ascorbic acid may react in the presence of hydroscopic ingredients, thus causing such a deleterious black discoloration.

Therefore, it has been found that the incorporation of micronutrients into, for example, a layered matrix, such as an edible particulate bead or tablet delivery system, may alleviate the deleterious interactions between each of these nutrient components, in particular iron (II) mineral sources, such a ferrous bis-glycinate, and high ferric ion reducing agents, such as ascorbic acid. For example, a core comprising a nucleus material (e.g., sugar) may be have applied to the core layered reactive nutrient components to form, for example, round or irregular oblong shaped beads, which are, for example, approximately 3-4/2-3 mm in diameter, which may have quick dissolving properties in aqueous liquids (i.e., are especially water-soluble), and which may include other components desired for taste and flavor, for example, sugars, non-caloric sweeteners, and flavoring agents, such as enzyme-modified flavors (e.g., dairy flavors), fermentation flavors (e.g., dairy flavors), reaction flavors (e.g., chocolate, caramel), natural extracts (e.g., vanilla, coffee, chocolate), and combinations thereof. Non-limiting examples of other specific flavorants suitable for use herein may include butter pecan flavor, orange, lemon, lime, apricot, grapefruit, yuzu, sudachi, apple, grape, strawberry, pineapple, banana peach, melon, apricot, ume, cherry, raspberry, blueberry, butter, vanilla, tea, coffee, cocoa or chocolate, mint, peppermint, spearmint, Japanese mint, asafetida, ajowan, anise, angelica, fennel, allspice, cinnamon, camomile, mustard, cardamon, caraway, cumin, clove, pepper, coriander, sassafras, savory, Zanthoxyli Fructus, perilla, juniper berry, ginger, star anise, horseradish, thyme, tarragon, dill, capsicum, nutmeg, basil, marjoram, rosemary, bayleaf, wasabi, beef, pork, chicken, fish, crustacean, dried and smoked fish, seaweed, wine, whisky, brandy, rum, gin, liqueur, floral flavors, onion, garlic, cabbage, carrot, celery, mushroom, tomato, and combinations thereof. When added to water, these beads may readily dissolve, releasing the solubilized micronutrients in a short period of time. The beads may also be consumed as a food without the need for water dissolution.

Embodiments of the present invention for micronutrient delivery in foods, beverages, nutritional supplements, etc., may for, for example, be in the form of a mixture of particulate beads comprising one or more iron (II) mineral sources and particulate beads comprising one or more high ferric ion reducing agents, where the respective beads are formed separately, may be in a dual or multiple layer, dry state form, such as edible beads or tablets, where the iron (II) mineral sources and the high ferric ion reducing agent are present in separately formed layers of the same beads, in separate segments, sectors, layers, etc., of the same tablet, etc., for delivery of, for example, at least 10% RDA of highly bioavailable minerals that include iron, as well as optionally calcium, vitamins, such as vitamin A, B-vitamins, vitamin C, vitamin D, vitamin E, as well as other trace minerals such as zinc, magnesium, manganese, and copper which may be important nutrients for growth and age-related health. Embodiments of the bead delivery products (such as a mixture of separately formed iron (II) mineral source beads and separately formed high ferric ion reducing agent beads of sufficiently small particle size diameter) may also provide for relatively fast dissolution in water and without detrimental affects to taste, e.g., chalkiness and “metallic” aftertastes. Embodiments of the bead products may also optionally comprise a level of calcium of, for example, from about 1.0 to about 20% by weight of the product (such as from about 3.0 to about 15% by weight of the product) so as to provide, for example, from about 100 to about 500 mg of calcium per dosage, in addition to iron (II) mineral sources (e.g., reduced iron as ferrous bis-glycinate) at a level of, for example, of from about 0.05 to 0.6% by weight of the product, (such as from about 0.05 to about 0.2% by weight of the product) to provide, for example, from about 1.8 to about 9 mg of iron (II) per dosage, and in the presence of ascorbic acid in an amount of, for example, at least about 0.1% by weight of the product (such as at least about 1.7% by weight of the product) to provide, for example, at least about 60 mg of ascorbic acid per dosage.

It has also been found that there may be at least two key factors for achieving higher delivery levels of soluble iron (and optionally other minerals such as calcium), in the presence of vitamin C fortification in a dry solid delivery system, such as in an edible bead form. The first factor is the preparation of, for example, a layered matrix comprising a reduced iron source (such as ferrous bis-glycinate) to provide at least about 0.05% reduced iron by weight of the product, for example, at least about 1.8 mg of reduced iron per dosage, optionally with a soluble calcium mineral source (such as calcium citrate malate) to provide, for example, at least about 1.0% of calcium by weight of the product (such as at least 3.0% of calcium by weight of the product), for example, at least about 100 mg of calcium per dosage, and in the presence of combined citric acid and malic acid in an amount of, for example, from about 2 to about 50% by weight of the product, and in a weight ratio of, for example, citric acid:malic acid in the range of, for example, from about 4:1 to about 1:3, such as from about 2:1 to about 1:3 (e.g., from about 2:1 to about 1:1.5), respectively. Additional components may include sugars, such as sucrose, fructose, glucose, corn syrup solids, etc., non-caloric sweeteners such as aspartame, sucralose, glycyrrhizin, saccharin, acesulfame-K, cyclamates, etc., and mixtures thereof; starch, including, by way of example, any plant based starch such as tapioca, corn, soy, wheat, sorghum, or rice, as well as mixtures thereof; starch derivatives such as modified starches, dextrins, maltodextrins, etc.; other polysaccharides such as microcrystalline cellulose, polydextrose, edible gums, etc.; flavors, flavorants, flavoring agents, etc. Embodiments of a layered bead product as described herein may be, for example, formulated and prepared to have a dissolution rate in water to provide, for example, at least 70% by weight of dissolved solids, such as at least 90% by weight of the dissolved solids, in less than about 3 minutes at or about 20° C.

A second key factor is the avoidance of ascorbic acid (or any related isomers of ascorbic acid such as erythorbic acid, or the respective salts) being present in physical and/or chemical contact with the layered bead matrix of the iron (II) mineral sources (and optionally calcium mineral sources). It has been found that ascorbic acid may instantaneously react with, for example, ferrous bis-glycinate in the presence of water (i.e., ambient moisture) to immediately cause discoloration and to form a darker, inky product. This reaction may not be reversible and may cause negative color formation and metallic flavor aftertastes. Instead, in embodiments of the present invention, a vitamin C (e.g., ascorbic acid) layered bead matrix, with, for example, at least about 0.1% by weight (such as at least about 1.7% by weight) of the layered bead matrix of ascorbic acid (to provide, for example, at least about 60 mg of ascorbic acid per dosage), may be made similarly to the iron (II) mineral source (and optionally calcium mineral source-containing) layered bead matrix, which may also optionally contain sugars, such as sucrose, fructose, etc., other non-caloric sweeteners such as aspartame, sucralose, glycyrrhizin, saccharin, acesulfame-K, cyclamates, etc. and mixtures thereof; starch, including, by way of example, any plant based starch such as tapioca, corn, soy, wheat, sorghum, or rice, as well as mixtures thereof; starch derivatives such as modified starches, dextrins, maltodextrins, etc.; other polysaccharides such as microcrystalline cellulose, polydextrose, edible gums, etc., flavors, flavorants, flavoring agents, etc.; as well as other vitamins such as vitamin A, B-vitamins, vitamin D, vitamin E, etc. When formed similar to the iron (II) mineral source-containing (and optionally calcium-containing) beads, the ascorbic acid-containing beads may be formulated and prepared in this way to also have a relatively fast dissolution rate in water of, for example, less than about 5 minutes (such as less than about 3 minutes). In order to achieve target nutrient delivery, these ascorbic acid-containing beads may be made and blended with the iron (II) mineral source(s) (and optionally the calcium mineral source(s)) beads at, for example, a weight ratio of 2.5 of iron (II)-containing beads to 1.0 of ascorbic-containing beads, a weight ratio of 1.0 of iron (II)-containing beads to 1.0 of ascorbic-containing beads, or any other suitable weight ratio. The final resulting mixture comprising the iron mineral source(s)/calcium mineral sources(s)-containing beads and the ascorbic acid-containing beads may be prepared to be homogeneous in appearance and to be indistinguishable in dissolution properties.

The embodiments of these micronutrient layered beads formulated and prepared in embodiments of this invention may be used in a various food and beverage preparations (e.g., toppings, dry mixes, fillings), medical device or beverage applications, such as a delivery straw (e.g., drink straw), incorporated into dietary supplement products (e.g., gums, chews, bars), etc. See, for example, U.S. Pat. No. 8,334,003 (Baron), issued Dec. 18, 2012 (the entire disclosure and contents of which is herein incorporated by reference), which describes a drink straw containing (e.g., a single serving) flavored particulates that may be released (delivered) into a beverage when consumed.

An embodiment of the present invention may be in the form of iron (II) mineral source particulates (e.g., beads), as well as high ferric ion reducing agent (e.g., ascorbic acid) particulates, each of which may comprise, for example, regular or irregular shaped beads having a diameter in the range of, for example, from about 0.5 to about 10 mm, such as from 3 to 4 mm. For example, the iron (II) mineral source particulates may comprise beads containing a nutritionally supplemental amount of one or more calcium sources along with the iron (II) mineral sources, while the high ferric ion reducing agent particulates may comprise beads containing ascorbic acid in a weight ratio range of, for example, from about 3:1 to about 1:3 (such as from about 2.5:1 to about 1:1) of iron (II) mineral source particulate beads to high ferric ion reducing agent particulate beads.

In embodiments of processes for preparing products of the present invention in the form of mixtures of iron (II) mineral source particulates and high ferric ion reducing agent (e.g., ascorbic acid) particulates, these iron (II) mineral source particulates and high ferric ion reducing agent particulates may be formed by pan coating processes, air suspension coating processes (e.g., using a fluidized bed), dip coating processes, etc. For example, in pan coating processes used to form such particulates, a core comprising a nucleus material (e.g., such as sugar, starch, starch derivative, etc.) is provided as a support for the subsequently applied layer(s) comprising iron (II) mineral source(s) or high ferric ion reducing agent(s). In addition to the nucleus material, the core may optionally comprise other ingredients such as flavorants, colorants, etc.

In some embodiments, these other ingredients present in the core may be substantially water-insoluble, for example, flavorants such as chocolate. In those instances, the substantially water-insoluble material may be applied as an exterior coating on the nucleus material (e.g., sugar). In addition to the substantially water-insoluble ingredient(s), this coating applied to the nucleus material may further comprise: water or other aqueous liquids; one or more edible oils, one or more emulsifiers, one or more binders (e.g., starch, starch derivatives, etc.), etc. Suitable edible oils may include one or more of: canola oil, coconut oil, fractionated coconut oil, soybean oil, corn oil, peanut oil, low erucic acid rapeseed oil (canola oil), olive oil, safflower oil, high oleic safflower oil, MCT oil (medium chain triglycerides), sunflower oil, high oleic sunflower oil, sesame seed oil, palm and palm kernel oils, palm olein, marine oils, cottonseed oils, flaxseed oils, etc. Suitable emulsifiers for use herein may include one or more of: phosphatides such as such as phosphatidyl choline, phosphatidylethanolamine, phosphatidylinositol, as well as mixtures thereof, for example, compositions containing one or more of these phospholipids such as lecithins, cephalins and plasmalogens, glycoplipids such as cerbroside and glycolipid-containing compositions, etc.; monoglycerides and/or diglycerides such as ethoxylated mono- and di-glycerides, fumarated esters of monoglycerides or their alkali metal salts, alkanoyl lactylates or their metal salts, monoglycerides and/or diglycerides of C₁₆-C₁₈ saturated and/or unsaturated fatty acids or C₂₀-C₂₄ saturated and/or unsaturated fatty acids, or their alkali metal salts, as well as mixtures thereof; sorbitan esters of C₁₂-C₁₈ saturated and/or unsaturated fatty acids such as sorbitan monolaurate (Span 20), sorbitan monostearate (Span 60), sorbitan monooleate (Span 80), etc.; polyoxyethylene sorbitan monoesters of C₁₂-C₁₈ saturated and/or unsaturated fatty acids such as polyoxyethylene sorbitan monolaurate (Polysorbate 20 and Tween 20), polyoxyethylene sorbitan monostearate (Polysorbate 60 and Tween 60), polyoxyethylene sorbitan monooleate (Polysorbate 80 and Tween 80), etc.; propylene glycol monoesters of C₁₂-C₁₈ saturated and/or unsaturated fatty acids such as propylene glycol monostearate; glycerol lactopalmitate, sodium stearoyl fumarate, calcium stearoyl-2-lactylate, etc.

After the core is prepared, the iron (II) mineral source particulates may be formed by adhering to the core (including a core having applied thereto the above described exterior coating) one or more layers comprising the iron (II) mineral source(s), as well as other mineral sources such as calcium, binders (e.g., starch, starch derivatives such as maltodextrin, etc.), edible acids (e.g., citric acid, malic acid, etc.), flavorants, colorants, etc. Similarly, the high ferric ion reducing agent (e.g., ascorbic acid) particulates may also be formed by adhering to the core (including a core having applied thereto the above described exterior coating) one or more layers comprising the high ferric ion reducing agent (e.g., ascorbic acid), as well as other vitamins, binders (e.g., starch, starch derivatives such as maltodextrin, etc.), edible acids (e.g., citric acid, malic acid, etc.), flavorants, colorants, etc. These separately formed iron (II) mineral source particulates and high ferric ion reducing agent particulates may then be combined, blended, mixed, etc., to form products comprising mixtures of these particulates, or may alternatively be formed into a plurality of separate tablets wherein a portion of the tablets comprise the iron (II) mineral sources, while the remaining portion of the tablets comprise the high ferric ion reducing agent.

In some embodiments, the iron (II) mineral source particulates, as well as the high ferric ion reducing agent particulates, may be provided with an exterior protective barrier coating (e.g., hard “glassy” sugar coating) to further inhibit, minimize, reduce prevent, etc., chemical interactions between the iron (II) mineral source(s) and the high ferric ion reducing agent(s), especially in the presence of ambient moisture. In some embodiments, and to improve the rate solubility in aqueous liquids (e.g., water), these particulates may also include an edible carbon dioxide-generating bicarbonate component (e.g., sodium bicarbonate, potassium bicarbonate, etc.), in addition to an edible carboxylic acid component (e.g., a citric and/or malic acid, etc.) which generates bubbling, agitation, mixing, stirring, etc., in the aqueous liquid to which to particulates are added to assist in dispersing these particulates in the aqueous liquid. See PCT Appln. No. US 2013/043611 (Yang), filed May 31, 2013, the entire disclosure and contents of which is herein incorporated by reference.

Embodiments of the products of the present invention may also be in the form of tablets comprising, for example, alternating discrete layers comprising either the iron (II) mineral source(s) or the high ferric ion reducing agent(s) (e.g., wherein one adjacent layer of the alternating layers comprises the iron (II) mineral sources, and wherein the other adjacent layer of the alternating layers comprises the high ferric ion reducing agent), discrete segments, sections, etc., which each comprise either the iron (II) mineral source(s) or the high ferric ion reducing agent(s) (plus any other optional components such as other mineral sources such as calcium, other trace minerals, vitamins, binders (e.g., starch, starch derivatives such as maltodextrin, etc.), edible acids (e.g., citric acid, malic acid, etc.), flavorants, colorants, etc. Embodiments of tablets comprising alternating layers of the iron (II) mineral source(s) and the high ferric ion reducing agent(s) may be formed similar to the layered particles, for example, by starting with a core comprising the nucleus material(s) (optionally including an exterior coating), and then applying alternating layers comprising either the iron (II) mineral source(s) or the high ferric ion reducing agent(s) (plus any other optional components such as other mineral sources such as calcium, other trace minerals, vitamins, binders (e.g., starch, starch derivatives such as maltodextrin, etc.), edible acids (e.g., citric acid, malic acid, etc.), flavorants, colorants, etc. Embodiments of tablets comprising these discrete segments, sections, etc. of the iron (II) mineral source(s) or the high ferric ion reducing agent(s) may be prepared by melding, compressing, molding, squeezing, fusing, bonding joining, etc., the respective segments, sections, etc., together to form the composite tablet. In some embodiments, the outer most layer of the alternating layers of these tablets may also be provided with an exterior protective barrier coating (e.g., hard “glassy” sugar coating) to further inhibit, minimize, reduce prevent, etc., chemical interactions between the iron (II) mineral source(s) and the high ferric ion reducing agent(s), especially in the presence of ambient moisture. In some embodiments of these tablets, protective barrier materials (e.g., hard “glassy” sugar barrier materials) may also be interposed between the respective adjacent alternating layers, segments, sections, etc.

### EXAMPLES

Illustrative examples of embodiments of edible solid nutritional products or compositions are shown below:

### Example 1

A micronutrient fortified product delivery in the form of coated edible bead particles is formulated to have the following properties and characteristics (Table 1):

TABLE 1
Nutrition Specification: Serving per 3.5 g dose

| Calories | 11 | |
|---|---|---|
| Total Fat | 0.00 | gm |
| Sodium | 0.0 | gm |
| Total Carbohydrates | 2.9 | gm |
| Sugar | 1.7 | gm |
| Vitamin A | 20% | RDI |
| Vitamin C | 100% | RDI |
| Vitamin D | 30% | RDI |
| Iron | 20% | RDI |
| Iodine | 20% | RDI |
| Calcium | 10% | RDI |

For a 3.5 g dose of the finished coated bead particle product, a first bead component A is prepared from the following ingredients:

Component A

| Ingredients | % w/w |
|---|---|
| Sugar | 58.4 |
| Tapioca Starch | 14.3 |
| Maltodextrin | 6.0 |
| Ferrous Bis-glycinate* | 1.03 |
| Calcium Citrate Malate** | 17.2 |
| Citric Acid | 0.91 |
| Malic Acid | 1.37 |
| Canola Oil | 0.45 |
| Lecithin | 0.09 |
| Flavor | 0.20 |

*Calcium citrate malate, Albion Minerals, Clearfield, Utah
**Ferrochel ®, Albion Minerals, Clearfield, Utah

The bead particles are produced (e.g., at ambient temperatures) by first coating an edible nucleus material (e.g., “seed” sugar crystal) with a sugar syrup comprised of a mixture of the sugar, water, edible oil such as canola oil, and an emulsifier, such as lecithin, to form first coated bead particles (i.e., the core of the particles). A mineral premix is prepared from a blending of the calcium citrate malate, ferrous bis-glycinate, citric acid, malic acid, maltodextrin, starch, flavor component and minor coloring agents (in suitable amounts, for example, about 0.1% by weight of the total A component formulation, such as about 0.01% or less by weight of the total A component formulation). This premix is then divided into three portions and added successively to the first coated bead particles, with the purpose of successively adding layers to each bead particle. Once the ingredients are fully formed into the bead particles, the bead particles are dried for 30-60 minutes to remove final moisture (e.g., to less than about 2%).

A second bead component B is prepared similarly from the following ingredients:

Component B

| Ingredient | % w/w |
|---|---|
| Sugar | 60.5 |
| Tapioca Starch | 14.4 |
| Maltodextrin | 6.0 |
| Ascorbic Acid | 6.9 |
| Vitamin D | 0.12 |
| Vitamin A. Palmitate | 0.40 |
| Potassium Iodide | 0.02 |
| Calcium Citrate Malate* | 8.6 |
| Citric Acid | 0.95 |
| Malic Acid | 1.41 |
| Canola Oil | 0.45 |
| Lecithin | 0.09 |
| Flavor | 0.20 |

*Calcium citrate malate, Albion Minerals, Clearfield, Utah

The bead particles of component A and the bead particles of component B are then mixed in a ratio of 2.5 g to 1.0 g to provide a delivery dose of 3.5 g of the finished product having the nutritional content shown in Table 1 above.

### Example 2

A fast dissolving nutritional supplement with dual tablet delivery (2 tablets, each 3 g) to be used in 16 oz water is formulated from the following ingredients (Table 2):

TABLE 2

| Ingredient | Tablet A (% w/w) | Tablet B (% w/w) |
|---|---|---|
| Citric Acid | 27.84 | 27.84 |
| Malic Acid | 18.66 | 18.66 |
| Calcium Hydroxide | 15.64 | 15.64 |
| Sodium Bicarbonate | 16.76 | 16.76 |
| Ferrous bis-glycinate (20% Iron) | 0.75 | 0.00 |
| Ascorbic Acid | 0.00 | 2.83 |
| Vitamin D 100 | 0.03 | 0.03 |
| Maltodextrin | 10.13 | 8.05 |
| Flavor | 2.37 | 2.37 |
| Ace K | 0.78 | 0.78 |
| Sucralose | 0.21 | 0.21 |
| Magnesium Chloride | 1.61 | 1.61 |
| Polyethylene Glycol | 4.52 | 4.52 |
| Anthro Red Color | 0.70 | 0.70 |

For a 1 kg batch of a first tablet (Tablet A) containing iron (II), sodium bicarbonate (168 g) calcium hydroxide (156 g) and maltodextrin (101 g) are first well mixed into a homogeneous mix. The mixture is wetted with a solution of 95/5 w/w ethanol/water to created initial core granules. The citric acid (278 g), malic acid (187 g) acids are then added to begin layering onto the initially formed core of these granules. After this layering step, ferrous bis-glycinate and all the remaining ingredients are then added to the core of the granules, and then mixed together to provide a homogenous mixture of layered granules. The finished granules are then dried to a moisture content of less than 2%, e.g., less than 0.5%

A second tablet (Tablet B containing the ascorbic acid) is similarly prepared, for example, by first mixing well sodium bicarbonate, calcium hydroxide and maltodextrin, and forming this mixture into the core of the granules. Citric and malic acids are then layered onto the core of these granules, followed by ascorbic acid and all other ingredient to provide the final granule, which is then dried to a moisture content of less than 0.5%. The granules for respective Tablet A and Tablet B are then allotted and pressed into 3 g tablets with an approximate dimension of 200 mm in diameter and 50 mm in thickness. Tablets A and Tablets B may then be combined into a single dose package, and when added to 1 6 oz of water, generally dissolved in less than about 5 minutes.

All documents, patents, journal articles and other materials cited in the present application are hereby incorporated by reference.

Although the present invention has been fully described in conjunction with several embodiments thereof, it is to be understood that various changes and modifications may be apparent to those skilled in the art. Such changes and modifications are to be understood as included within the scope of the present invention as defined by the appended claims, unless they depart therefrom.

1. A product comprising a solid edible nutritional composition, which contains:
a nutritionally supplemental amount of one or more iron (II) mineral sources; and
a high ferric ion reducing agent comprising one or more of: ascorbic acid, edible ascorbic acid salts, edible ascorbic acid esters, erythorbic acids, edible erythorbic acid salts, or edible erythorbic acid esters in amount sufficient to measurably retard conversion of the iron (II) mineral sources from ferrous to ferric species when the solid edible nutritional composition is solubilized in an aqueous liquid;
wherein the iron (II) mineral sources and the high ferric ion reducing agent are physically and/or chemically separated to minimize chemical interaction in the presence of ambient moisture.

2. The product of claim 1 which further comprises a nutritionally supplemental amount of one or more calcium mineral sources.

3. The product of claim 2, wherein the one or more calcium mineral sources comprise a chelated calcium citrate malate complex in an amount sufficient to provide a level of solubilized calcium of at least about 1.0% by weight of the product, wherein the weight ratio of citrate to malate of the chelated calcium citrate malate complex is from about 4:1 to about 1:3.

4-5. (canceled)

6. The product of claim 1, wherein the iron (II) mineral sources comprise ferrous bis-glycinate in amount sufficient to provide a level of solubilized ferrous iron of at least about 0.05% by weight of the product.

7. The product of claim 6, wherein the high ferric ion reducing agent comprises ascorbic acid in an amount of at least about 0.1% by weight of the product.

8. (canceled)

9. The product of claim 1, which further comprises vitamin D in an amount sufficient to provide at least about 10% of the RDA of vitamin D.

10. The product of claim 1, which further comprises one or more sources of trace minerals other than iron or calcium in an amount sufficient to provide at least about 10% of the RDA of each trace mineral.

11. The product of claim 1, which is in the form of a plurality of tablets, wherein a portion of the tablets comprise the iron (II) mineral sources, and wherein the remaining portion of the tablets comprise the high ferric ion reducing agent, and wherein the ratio of the tablets comprising the iron (II) mineral sources to the tablets comprise the high ferric ion reducing agent is 1:1.

12. (canceled)

13. The product of claim 11, wherein each of the plurality of tablets have a diameter in the range of from about 50 to about 250 mm.

14. (canceled)

15. The product of claim 1, which is in the form of a tablet comprising alternating layers, wherein one adjacent layer of the alternating layer comprises the iron (II) mineral sources, and wherein the other adjacent layer of the alternating layer comprises the high ferric ion reducing agent.

16. The product of claim 14, wherein the tablet comprises a protective barrier material interposed between adjacent layers.

17. The product of claim 15, wherein the tablet has an exterior protective barrier coating on an outer most layer of the alternating layers.

18. The product of claim 1, which is in the form of a tablet comprising discrete segments, where in at least one of the discrete segments comprises the iron (II) mineral sources and wherein at least one of the discrete segments comprises the high ferric ion reducing agent.

19. The product of claim 18, wherein the tablet comprises a protective barrier material interposed between adjacent segments comprising the iron (II) mineral sources and the high ferric ion reducing agent.

20. A product comprising a solid particulate edible nutritional mixture, which contains:
a nutritionally supplemental amount of iron (II) mineral source particulates comprising one or more iron (II) mineral sources, each of the iron (II) mineral source particulates comprising:
a first edible core; and
at least one edible layer comprising one or more iron (II) mineral sources surrounding the first core; and
high ferric ion reducing agent particulates in amount sufficient to measurably retard conversion of the iron (II) mineral sources from ferrous to ferric species when the solid particulate edible nutritional mixture is solubilized in an aqueous liquid, each of the high ferric ion reducing agent particulates comprising;
a second edible core; and
at least one edible layer on the second core and comprising one or more of: ascorbic acid, edible ascorbic acid salts, edible ascorbic acid esters, erythorbic acids, edible erythorbic acid salts, or edible erythorbic acid esters;
wherein the coated iron (II) mineral source particulates and the coated high ferric ion reducing agent particulates minimally interact chemically in the presence of ambient moisture.

21. The product of claim 20, wherein the iron (II) sources comprise ferrous bis-glycinate in an amount in the range of from about 0.05 to about 0.6% by weight of the product.

22. The product of claim 21, wherein the iron (II) sources comprise ferrous bis-glycinate in an amount in the range of from about 0.05 to about 0.2% by weight of the product.

23. The product of claim 20, wherein the high ferric ion reducing agents comprise ascorbic acid is in an amount of at least about 0.1% by weight of the product.

24. (canceled)

25. The product of claim 20, wherein the iron (II) mineral source particulates further comprise a nutritionally supplemental amount of one or more calcium mineral sources in an amount in the range of from about 1.0 to about 20% by weight of the product.

26. The product of claim 25, wherein the calcium mineral sources comprise a calcium citrate malate chelate complex, and wherein the weight ratio of citrate to malate is in the range of from about 2:1 to about 1:3.

27-29. (canceled)

30. The product of claim 20, wherein the iron (II) mineral source particulates are in the form of beads comprising ferrous bis-glycinate, wherein the high ferric ion reducing agent particulates are in the form of beads comprising ascorbic acid, and wherein the iron (II) mineral source beads and the high ferric ion reducing agent beads are in a weight ratio range of from about 3:1 to about 1:3 of the (II) mineral source beads to the high ferric ion reducing agent beads.

31. (canceled)

32. The product of claim 20, wherein the iron (II) mineral source particulates and the high ferric ion reducing agent particulates have a particle size diameter in the range of from about 2 to about 3 mm.

33. (canceled)

34. The product of claim 20, which comprises a level of total acids in the range of from about 0.03 to about 0.05% by weight of the product.

35. (canceled)

36. The product of claim 20, which further comprises a delivery straw which provides a single serving of solid particulate edible nutritional mixture.

37. A process for preparing a solid particulate edible nutritional mixture, which comprises the following steps:
(a) forming iron (II) mineral source particulates by applying at least one edible layer comprising one or more iron (II) mineral sources to a first edible core;
(b) forming high ferric ion reducing agent particulates by applying at least one edible layer comprising one or more of: ascorbic acid, edible ascorbic acid salts, edible ascorbic acid esters, erythorbic acids, edible erythorbic acid salts, or edible erythorbic acid esters, to a second edible core; and
(c) combining a nutritionally supplemental amount of the coated iron (II) mineral source particulates with the high ferric ion reducing agent particulates in an amount sufficient to measurably retard conversion of the iron (II) mineral sources from ferrous to ferric species when the solid particulate edible nutritional mixture is solubilized in an aqueous liquid, wherein the iron (II) mineral source particulates and the high ferric ion reducing agent particulates minimally interact chemically in the presence of ambient moisture.

38. The process of claim 37, wherein step (a) comprises applying to one or more layers comprising the iron (II) mineral sources a first core comprising a sugar, and wherein step (b) comprises applying to one or more layers comprising the high ferric ion reducing agents a second core comprising a sugar.

39. The process of claim 37, wherein each of steps (a) and (b) are carried by pan coating.

40. The process of claim 39, wherein the iron (II) mineral source particulates formed by step (a) and the high ferric ion reducing agent particulates formed by step (b) have a particle size diameter in the range of from about 2 to about 3 mm.

41. (canceled)

42. The process of claim 37, wherein the iron (II) mineral source layers of step (a) and the high ferric ion reducing agent layers applied of step (b) each comprise citric acid and malic acid in weight ratio of from about 2:1 to about 1:3 by weight.

43. The process of claim 41, wherein the iron (II) mineral source layers of step (a) further comprise a nutritionally supplemental amount of a chelated calcium citrate malate complex.
